(19) United States
(12) Patent Application Publication
(10) Pub. No.: US 2005/0227203 A1
(43) Pub. Date: Oct. 13, 2005

(54) Apparatus and Method for Preparing and Installing Dental Restorations

(76) Inventor: Tal Kuperman, Boynton Beach, FL (US)

Correspondence Address: JOHN C. SMITH, ESQ., 2499 GLADES ROAD, SUITE 113, BOCA RATON, FL, 33431, US

(21) Appl. No.: 10/709,083

(22) Filed: Apr. 12, 2004

(51) Int. Cl. A61C 5/00

(52) U.S. Cl. 433/218

(57) ABSTRACT

A two-part crown assembly which allows the cosmetic surface of a crown to be manufactured prior to installation such that aesthetic appearance of the crown provides a high level of realism and a natural look to the observer. A coping attaches to the stub of the tooth and provides permanent support for the crown. The second part of the crown assembly is a prefinished anatomy which is attached to the coping. Both the coping and the prefinished anatomy are manufactured in a controlled environment. As a result, quality can be maintained at minimum standards with high levels of aesthetic quality in the finished crown. In addition, the dental professional can install a crown in a fraction of the time required by the prior art, which results in substantial savings for the dental professional and the patient. The coping has a prepared surface that is configured to accept a prefinished anatomy. In turn, the prefinished anatomy also has a prepared surface which matches that of the coping. During installation, the coping is first attached to a tooth prep. Once securely attached to the prep, the prefinished anatomy is attached to the prep. The prefinished anatomy may be attached by any suitable technique, such as porcelain, acrylic, or other suitable substance. The prefinished anatomy eliminates the need for the dental professional to spend extended amounts of time creating the anatomy, since they have been prepared under controlled conditions by highly skilled personnel at a manufacturing facility.

### BACKGROUND OF INVENTION

1. Technical Field

The present invention relates to dental restoration devices and installation methods. In particular, it relates to a multi-piece crown that has a prefinished onlay or inlay prefinished anatomies for lingual, buckle, and/or occlusal surfaces that attach to a separate crown base that is soft uncured porcelain or acrylic. The separate crown base and prefinished anatomy are then put in an oven and bonded together to form a single finished crown. The prefinished anatomy reduces the need to shape the coping, and also provides a prefinished anatomy that provides a natural appearance with a high level of quality.

2. Background

The prior art has provided numerous dental restoration devices. One commonly used technique is the preparation of crowns for severely damaged teeth. The preparation of crowns is an elaborate multistep process. The process typically begins by making impressions of the patient's teeth. The impressions are used to create what is commonly referred to as a waxup which is used to create the final crown structure. Waxups are typically used to make the metal form that is used to create the final coping. Once the final round structure is installed, another technician provides the finishing touches on the external surface of the crown to make it resemble a real tooth. This is necessary because the crown will look too perfect without the addition of anatomy on the outer surface. As a result, these imperfections are required to ensure that the crown looks realistic.

Each step in the process of manufacturing and installing a dental crown is highly labor-intensive. In addition, many steps in this process require highly skilled labor which results in a relatively high cost for the finished product. In particular, the final step of creating the surface anomalies, striations, etc., which make the crown look authentic and natural, requires a dental professional who is both skilled in this art and has artistic ability.

Many of the steps in this process are currently performed by manufacturing facilities separate from the dentist's office. This is provided many benefits to the patient and to dental professionals. In particular, dental professionals benefit because they are able to obtain components at lower prices, and because components are manufactured under controlled conditions, they are also able to receive predictable unreliable levels of quality.

The last step in this process relies on the individual skill and artistic ability of the local dental technician or dentist who does the final installation of the crown and creates the required anatomy to the outer surface of the crown for the purpose of making it appear natural. Unfortunately, this last step is the one that creates the visual impact of the crown on the observer. Therefore, if a particular dentist or dental technician does a substandard job creating the anatomy on an installed crown, the resulting physical appearance may be inferior even though everything else about the crown may be superior in quality. It would be desirable to have method of insuring that the final anatomy on the surface of the crown had consistent levels in terms of its appearance and its ability to appear realistic and natural to an observer.

In addition to the need for a high level of skill when installing crowns, the dental professional is also required to invests a substantial amount of time when installing a crown. As a result, this time intensive process becomes very costly for the patient due to the amount of professional care required. It would be desirable to have a method of finishing a crown surface during the final installation process which took a minimal amount of time.

While prior art has provided many improvements in the fabrication and installation of crowns, it is failed to provide a method of insuring consistently high levels of aesthetic quality in regard to the surface treatment of the crown once installed. Likewise, the prior art has failed to provide a method of installing a crown, without the requirement of a lengthy anomaly and striation finishing process, for the purpose of reducing costs to the patient.

### SUMMARY OF INVENTION

The present invention provides a two-part crown assembly which allows the cosmetic surface of a crown to be manufactured prior to installation such that aesthetic appearance of the crown provides a high level of realism and a natural look to the observer. The first part of the crown assembly is a coping that attaches to the stub of the tooth provides permanent support for the crown when installed. The second part of the crown assembly is an onlay, inlay, and/or occlusal prefinished anatomy which is preformed to securely attach to the coping. Both the coping and the prefinished anatomy are manufactured in a controlled environment. As a result, quality can be maintained at minimum standards with high levels of aesthetic quality in the finished crown. In addition, the dental professional can install a crown in a fraction of the time required by the prior art, which results in substantial savings for the dental professional and the patient.

The coping is designed with a prepared surface that has a standard configuration for accepting a prefinished anatomy. In turn, the prefinished anatomy also has a standard configuration which matches that of the coping. During the installation process, the coping is first attached to a prep which was formed from the original tooth. Once securely attached to the prep, the dental professional then attaches the prefinished anatomy. Any suitable technique, such as porcelain, acrylic, or other suitable adhesive, can be used to attach the prefinished anatomy. The prefinished anatomy eliminates the need for the dental professional to spend extended amounts of time creating the anatomy, since they have been prepared under controlled conditions by highly skilled personnel at a remote manufacturing facility.

### BRIEF DESCRIPTION OF DRAWINGS

FIG. 1A illustrates a prior art method of the repairing a chipped tooth. This figure is a front view of a damaged tooth prior to repair.

FIG. 1B illustrates the chipped tooth of FIG. 1A after being prepped for repair using a prior art method.

FIG. 1C illustrates the chipped tooth of FIG. 1A after the tooth has been reconstructed using a prior art method.

FIG. 1D illustrates the chipped tooth of FIG. 1A after the surface of the tooth has been cosmetically treated.

FIG. 2A illustrates another prior art method of implanting a tooth. This figure illustrates the implantation of a threaded metal rod into a jawbone prior to attachment of a post.

FIG. 2B illustrates the next step in the prior art method shown in FIG. 2A. In this figure, the post is attached to the rod and the replacement tooth is about to be attached to the post.

FIG. 2C illustrates the final step in the prior art method shown in FIG. 2A. This figure is a cutaway view showing the post inside of the tooth after mounting.

FIG. 3A illustrates a prior art method of installing a crown. This figure illustrates a damaged tooth prior to repair.

FIG. 3B illustrates the damage to shown in FIG. 3A after it has been reduced in size to form a prep. Also shown in this figure is a crown which is about to be installed.

FIG. 3C illustrates the repaired tooth after the crown has been installed on the prep.

FIG. 3D illustrates a cutaway side view of the installed crown shown in FIGS. 3B-C.

FIG. 4A illustrates a perspective view of a prior art crown installed on a tooth prep. This view illustrates the crown prior to adding the finishing anatomy.

FIG. 4B illustrates the prior art crown shown in FIG. 4A after the anatomy has been added.

FIG. 5A illustrates a preferred embodiment of the coping prior to installation of the prefinished anatomy. The coping is temporarily installed on the prep to ensure it is the proper size.

FIG. 5B illustrates a preferred embodiment of the prefinished anatomy being aligned with the coping.

FIG. 5C illustrates a preferred embodiment of the prefinished anatomy after it has been permanently bonded to the coping and then permanently installed on the prep.

FIG. 5D illustrates the preferred embodiment shown in FIG. 5A. In this figure, the coping is shown without the prefinished anatomy.

FIG. 6A is a side view of a preferred embodiment of the invention showing the coping installed on a tooth prep. This illustration provides a more detailed view of the side of the prepared surface which secures to a prefinished anatomy.

FIG. 6B is a side view of a preferred embodiment of the prefinished anatomy prior to its attachment to a coping.

FIG. 6C is a side view of a preferred embodiment of the prefinished anatomy after bonding to a coping and after permanent installation on a tooth prep.

FIG. 7A illustrates a side end view of a preferred embodiment of the prefinished anatomy prior to installation on a coping.

FIG. 7B illustrates a side end view of a preferred embodiment of the prefinished anatomy after installation on a coping.

FIG. 8 is a top view of a preferred embodiment of the invention in which the prefinished anatomy is shown installed on the coping. This figure illustrates the prefinished anatomy after the crown is installed.

FIG. 9 is a front view of an alternative preferred embodiment in which the prefinished anatomy is used in place of a prior art veneer.

### DETAILED DESCRIPTION

Prior to a detailed discussion of the figures, a general overview of the system will be presented. The invention provides a method and apparatus that allows a dental technician, even one who has limited skills, to rapidly install a high-quality crown in a minimal amount of time. The invention provides a crown that comes in the form of a coping having a generic shape which attaches to the prep of a tooth that has been prepared for crown. Prep structures are well known on the art and do not need to be discussed further herein. Once the coping is attached to the tooth prep, an appropriate prefinished anatomy is selected to match the particular tooth's shape and color. The prefinished anatomy is then attached to the coping to complete the crown.

While prior art crowns are unfinished and require aesthetic finishing work, such as anatomy, to be added after installation of the crown on the patient's tooth prep, the prefinished anatomy has been prefinished to add the anatomy. As a result, the dental technician only needs to select the appropriate prefinished anatomy and adhere it to the coping. By eliminating the need for the dental technician to perform this final artwork, two significant benefits are achieved.

The first benefit is that a substantial amount of time is saved. As a result of this time savings, the dental technician becomes more efficient by being able to install more crowns within a day. This increases the profitability of the dental professional. In addition, it provides benefits to the patient as well. When the dental professionals profitability is increased, it allows the costs of providing those services to the patient to be reduced.

The second benefit provided by the invention is that it provides a uniformly high-quality aesthetically pleasing finished crown to the patient. In effect, it allows a technician having average skills to achieve results that equal the work produced by highly skilled technicians. While quality variations were common in the prior art due to the variation in skills of the dental technician doing the finishing work, the use of prefinished prefinished anatomies guarantees that the high-quality finish will always be provided. This also provides multiple benefits. Clearly, the patient benefits from a finished crown that is more aesthetically pleasing. In addition, the dental service also benefits because it allows technicians having lower levels of skill to produce a high quality finished crown in a rapid fashion.

It is envisioned that in the ordinary course of use, a dental facility will stock a kit, or prefinished anatomy supply, having a wide variety of surface treatments. These surface treatments preferably have a variety of color tones, anomaly and striation patterns, and other surface treatments, such that the dental technician can select a prefinished anatomy that best matches the surrounding teeth of the patient. The prefinished anatomy supply should preferably have a sufficient inventory to create a finished crown for any type of tooth.

The prefinished anatomies can be designed for buckle surfaces, lingual surfaces, or occlusal surfaces, depending on the nature of the work being done. In addition, a variety of material can be used to create these crowns. Their surfaces can be porcelain, acrylic, or any other material that is suitable for use. The coping can be fabricated with a metal underlayment, a porcelain and metal underlayment, or fabricated from a nonmetallic material, etc. The only requirement is that the material selected to make the coping the satisfactory for its intended purpose. The coping may have and outer surface which is fabricated from porcelain, acrylic, or any other suitable material. The only physical requirements for the coping is that it should have no undesirable effects on the patient, should supply a suitably pleasing aesthetic appearance, should have structural strength, should have good wear characteristics, and should be fabricated from a material that is attachable to a prefinished anatomy. With those restrictions in mind, any material can be used to fabricate the coping.

The materials used to fabricate the prefinished anatomies can also very provided that they are compatible with the materials used to fabricate coping, and have similar physical requirements to those described above in regard to the coping.

The process used to attach a prefinished anatomy to coping also requires a suitable method of bonding the two together. The bonding agent should be something that provides both a secure attachment of the prefinished anatomy to the coping, while at the same time not detracting from the aesthetic appearance of the finished crown.

Once the prefinished anatomy has been secured to the coping, the minor amount of finish work is done by the dental technician to complete the crown and eliminate any minor imperfections resulting from the attachment of the prefinished anatomy to the crown.

The following list illustrates the productivity improvement that can be achieved using the instant invention. The same benefits are derived regardless of the material used for the crown (e.g. porcelain or acrylic). The list shows the steps used for installing a conventional crown in comparison to the time taken for installing the system employed by this invention. The steps are well known in the art. Typical times are as follows:

Performance Improvement Over The Prior Art

| Step | Typical Prior Art Time | | Typical Invention Time | |
|---|---|---|---|---|
| Buildup (base) | 15 | minutes | 5 | minutes |
| Cut-in (grind) | 15 | minutes | 5 | minutes |
| Glaze | 1-2 | minute | 1-2 | minute |
| Carve | 3-4 | minutes | 0-0.5 | minutes |
| Total | 34-36 | minutes | 11-12.5 | minutes |

As can be seen, the use of a prefinished anatomy dramatically decreases the amount of time required by the prior art to execute the Buildup, Cut-in, and Carve steps. As a result of the prefinished anatomy provided by the invention, the total time required to finish a crown has been reduced to approximately one third of the time required by the prior art. This provides the dental professional with the ability to install many more crowns over the course of a workday. Of course, the substantial time-saving translates directly into profitability of the dental care provider. Likewise, it allows the dental care provider to avoid price increases, or to decrease prices to the patient.

In addition to the time savings, discussed above, the patient also receives the benefit of a high-quality service which may be beyond the technical ability of a particular technician to provide using prior art system. The invention provides crowns with consistently high aesthetic quality that may not be available from a particular dental care provider, and can simultaneously be provided at a lower price than that possible using the prior art. As a result, the invention benefits both the dental care provider and the patient.

Having discussed the features and advantages of the invention in general, we turn now to a more detailed discussion of the figures.

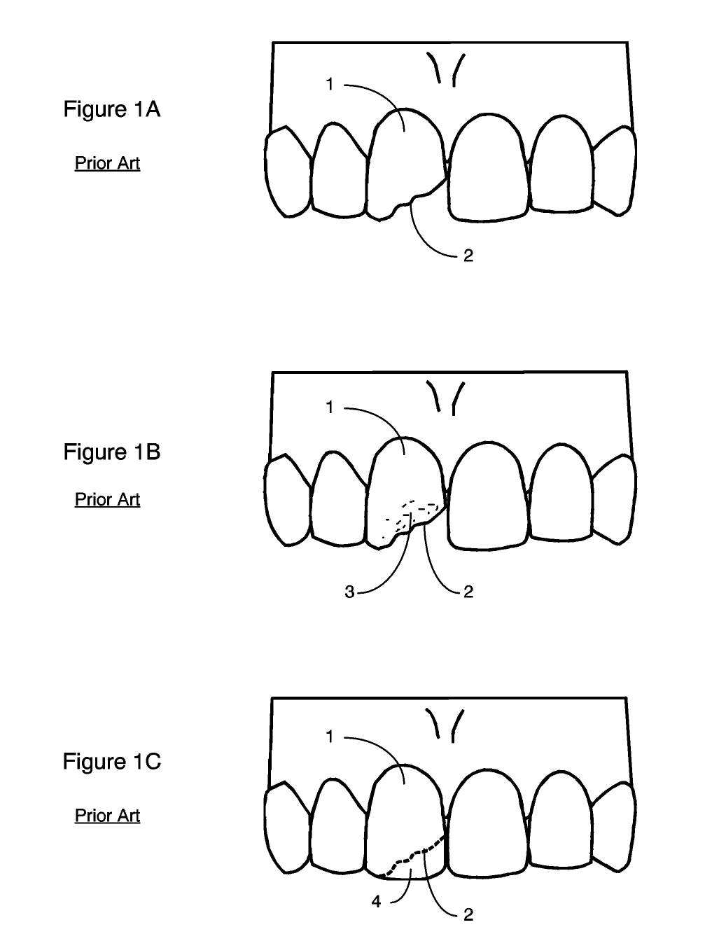

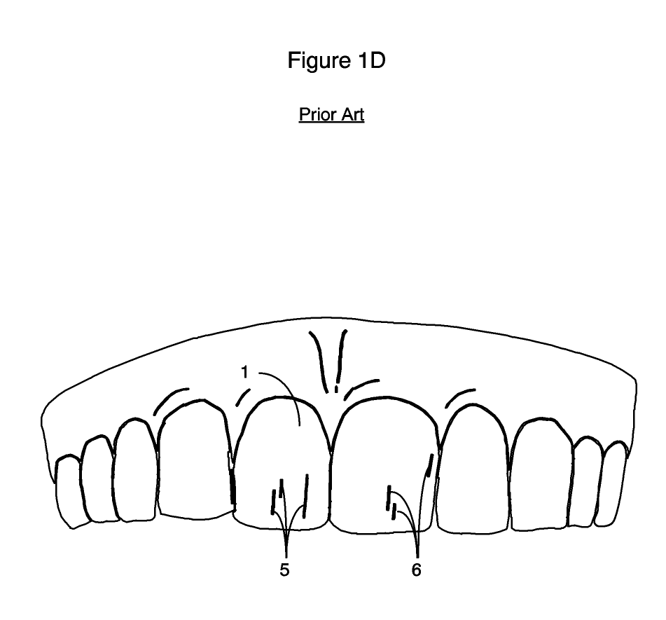

FIG. 1A illustrates a prior art method of the repairing a chipped tooth 1. This figure is a front view of a damaged tooth 1 prior to repair. In this figure, a portion of the tooth 1 has broken off along fracture line 2 When repairing chipped tooth 1, it will first be prepared to accept attachment of a porcelain veneer or replacement tooth edge.

FIG. 1B illustrates the chipped tooth 1 of FIG. 1A after the area 3 adjacent to fracture line 2 has been prepared for installation of a synthetic tooth extension.

FIG. 1C illustrates the chipped tooth 1 of FIG. 1A after the tooth 1 has been reconstructed by attaching a synthetic tooth extension 4.

FIG. 1D illustrates the chipped tooth 1 of FIG. 1A after the surface of the tooth has been finished to add anatomy 5. In this figure, the anatomy 5 is intended to resemble and be compatible with the anatomy 6 which naturally occurs in the adjacent undamaged tooth. As is the case with other prior art methods of repairing damaged teeth, this prior art method requires a substantial amount of skill on the part of the technician or dental professional in order to properly match the anatomy of the repaired tooth numeral 1 to the anatomy of the adjacent teeth.

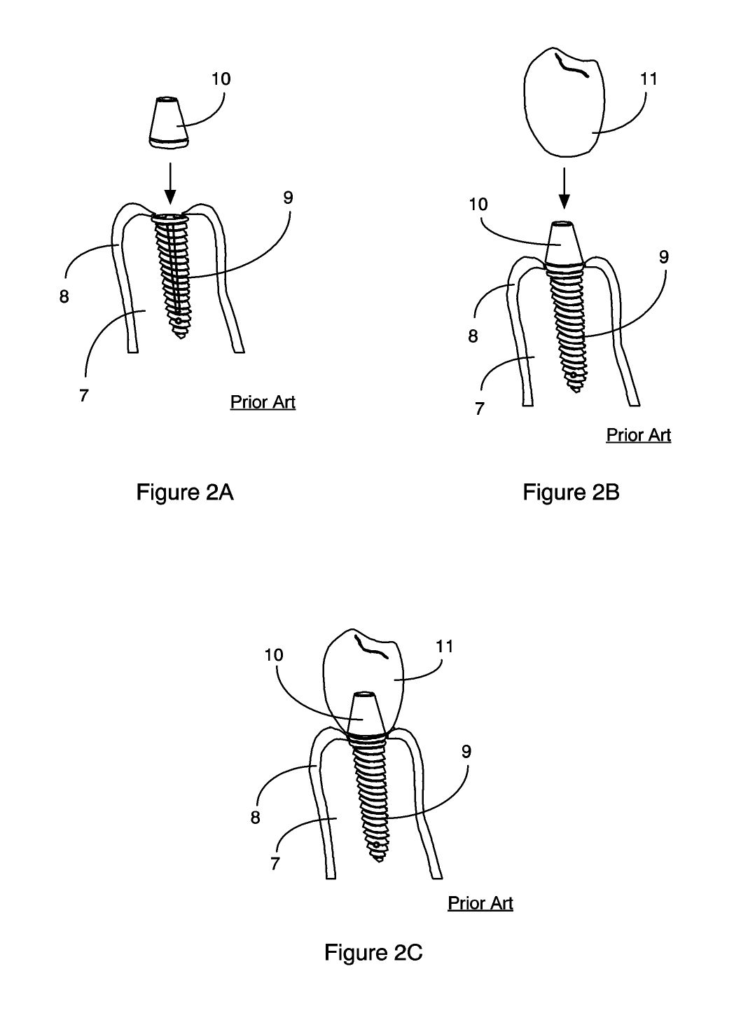

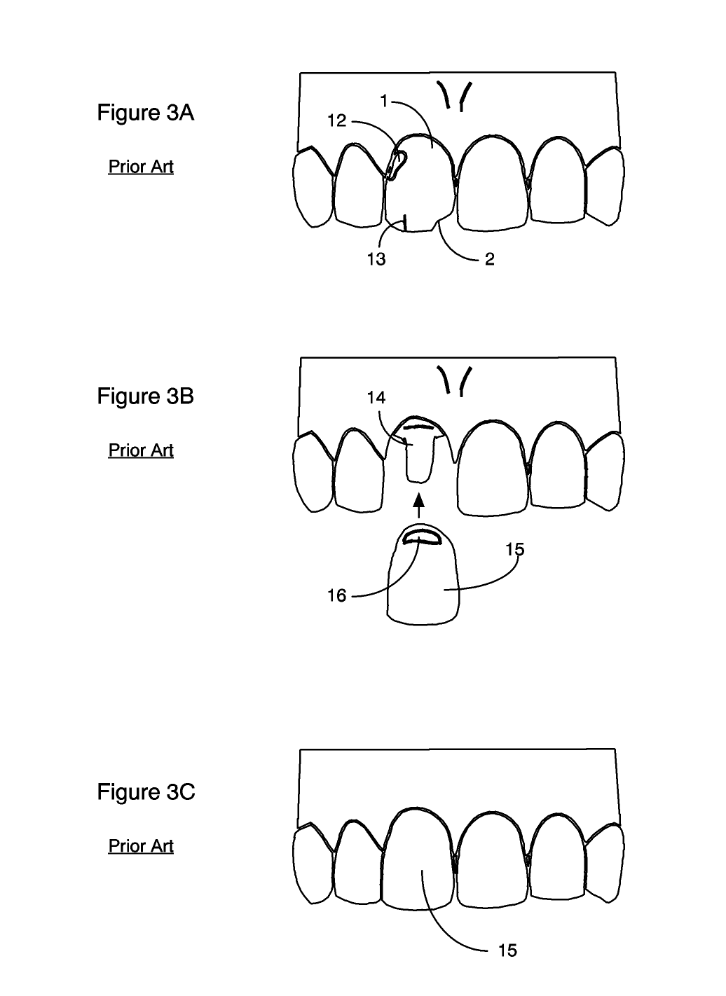

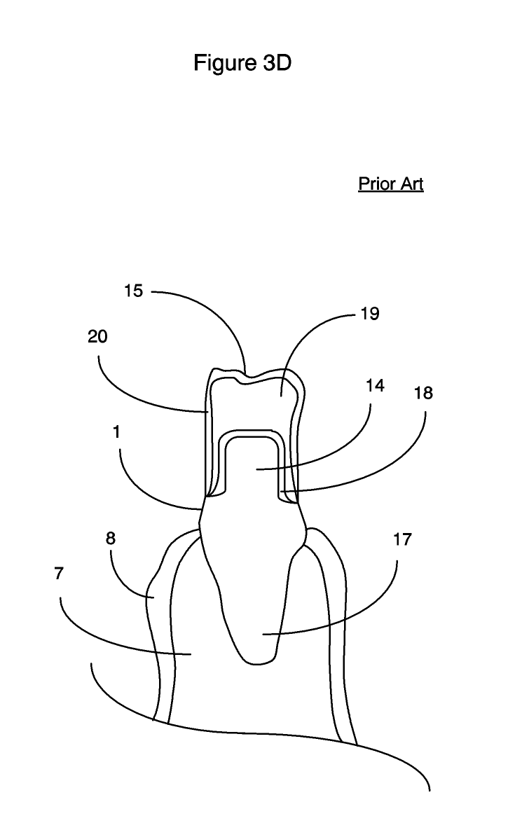

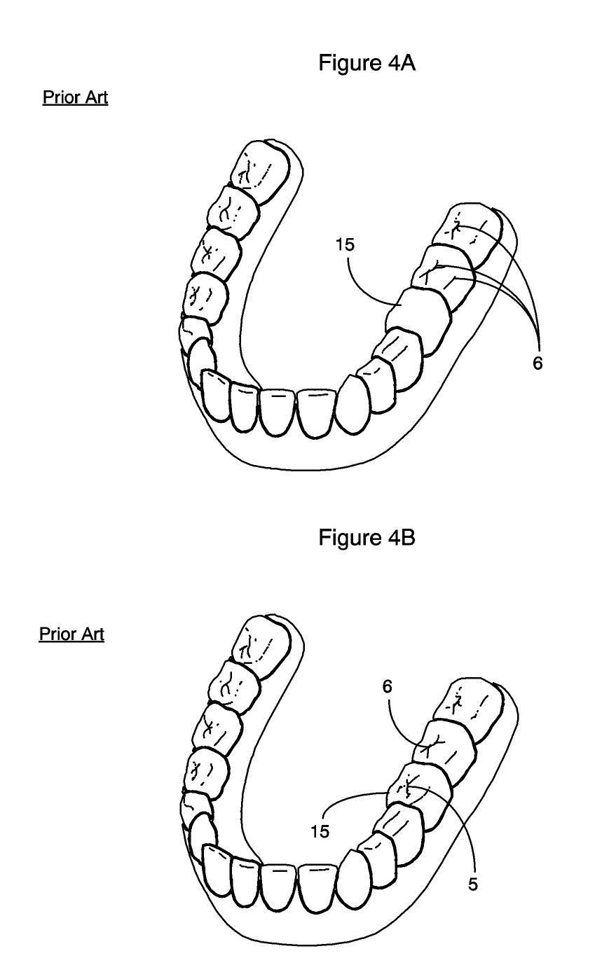

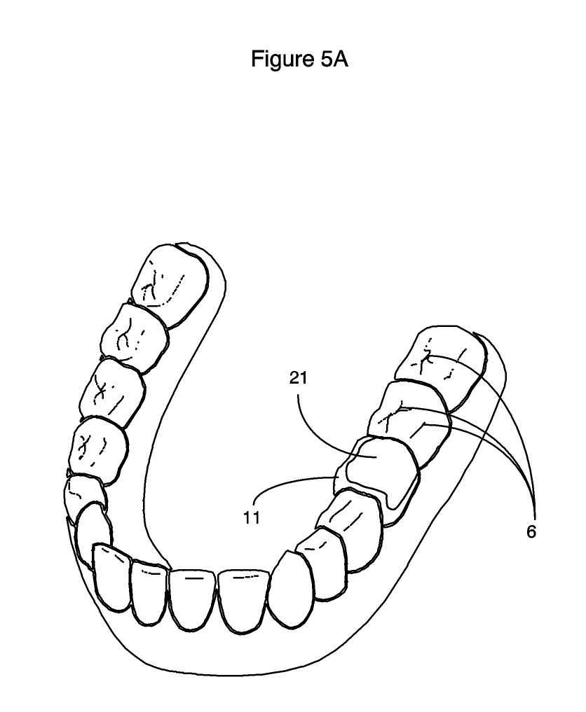

FIG. 2A illustrates a cutaway side view of a jawbone 7 that illustrates a prior art method of implanting a replacement tooth 11 (shown in FIG. 2B). This figure illustrates the implantation of a threaded metal rod 9 into a jawbone 7 prior to attachment of a post 10. The jawbone is shown surrounded by soft tissue 8. The post 10 is functionally equivalent to a prep 14 (shown below in FIG. 3B), with the exception that the post 10 is a fabricated device and the prep 14 is carved from an actual tooth. For ease of discussion, separate terms are used to describe these similar structures within this specification.

FIG. 2B illustrates the next step in the prior art method shown in FIG. 2A. In this figure, the post 10 is attached to the rod 9 and a replacement tooth 11 is about to be attached to the post 10.

FIG. 2C illustrates the final step in the prior art method shown in FIGS. 2A-B. This figure is a cutaway view showing the post 10 inside of the tooth 11 after the tooth 11 has been secured to the post 10. As was the case with the other prior art techniques discussed above, the implantation of a replacement tooth 11 also requires the dental technician to have a substantial level of skill in order to create a natural looking to do with proper anatomy.

FIG. 3A illustrates a prior art method of installing a crown 15 (shown in FIG. 3C). This figure illustrates a damaged tooth 1 prior to repair. Replacement with a crown 15 may be required for any number of problems, such as extensive cavities 12, severe cracks 13, large chips such as that illustrated by fracture line 2, etc.

FIG. 3B illustrates the damaged tooth shown in FIG. 3A after it has been reduced in size to form a prep 14. Also shown in this figure is a crown 15 which is about to be installed onto the prep 14. The crown 15 has a slot 16 which is sized to fit over the prep 14.

FIG. 3C illustrates the repaired tooth 1 after the crown 15 has been installed on the prep 14. The crown 15 is bonded to prep 14 to secure it permanently in place. As was the case above in regard to the other prior art methods, attachment of a conventional prior art crown still requires a substantial amount work to finish the anatomy.

FIG. 3D illustrates a side cutaway view of the installed crown 15 shown in FIGS. 3B-C. This figure illustrates the soft tissue 8 which surrounds the jawbone 7. The jawbone 7 in turn holds the root 17 of the tooth 1. The upper portion of the tooth 1 has been reduced in size to form the prep 14 which is used to secure the crown 15 in place. The crown 15 has a coping 19, which may have an underlayment 18 between it and the prep 14. The underlayment 18 is typically secured to the prep 14 via adhesive. The underlayment 18 can be metal or any other suitable material.

A coping 19 is attached to the underlayment 18. On top of the coping 19 is a cosmetic surface 20 which is unfinished. This cosmetic surface 20 is the surface which is created during the buildup step, described above. When the cosmetic surface 20 is complete, the dental technician then grinds the cosmetic surface 20 to rough form (i.e., the cut-in step). Both of these steps are substantially reduced in time by the invention because the prefinished anatomy 22 needs only to be secured to the coping 19 and trimmed around the edges to create finished look. The buildup and cut-in steps both require substantial skill on the part of the dental professional when using the prior art. However, the invention eliminates this need and allows a dental professional having only modest skills to create a crown that is superior in appearance.

In the final version, the crown 15 also has a layer of glaze which is used to create a natural appearance in the tooth. Again, this prior art technique requires essential skill on the part of the technician, and further requires a substantial amount of time to properly create a natural appearing anatomy of the finished crown.

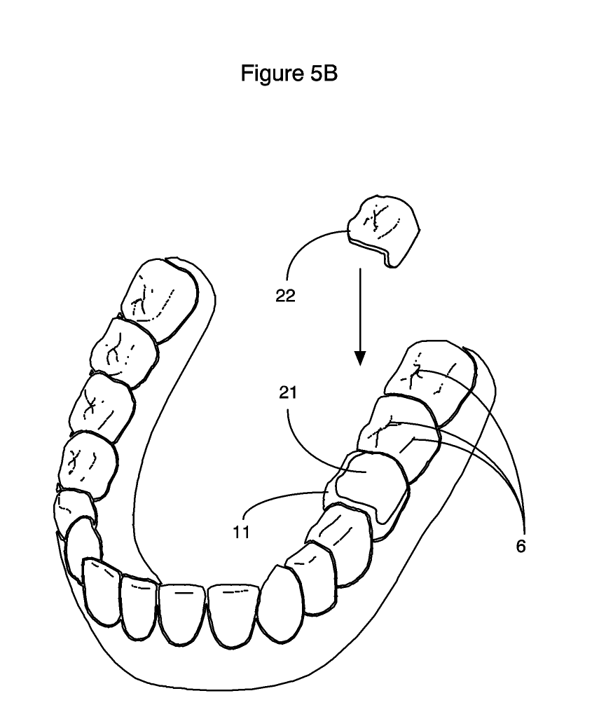

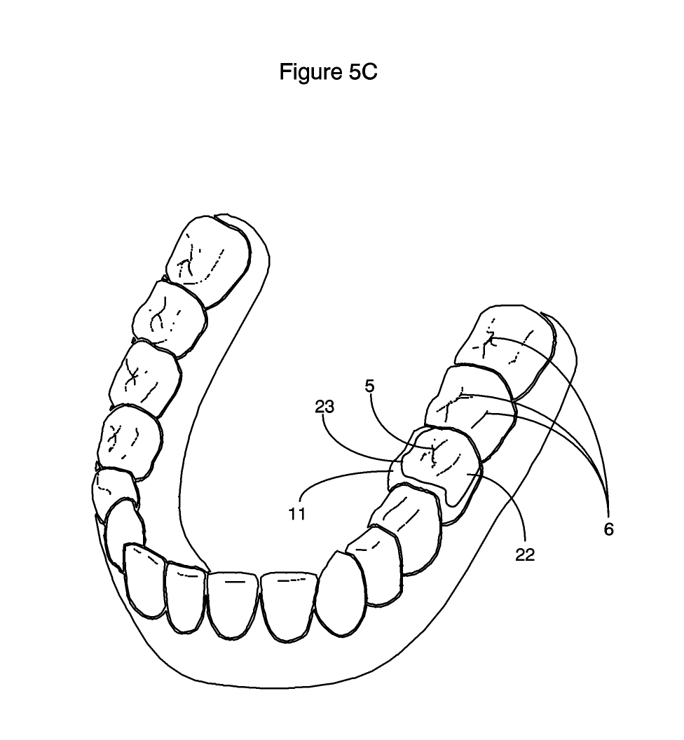

FIG. 4A illustrates a perspective view of a prior art crown 15 installed on a tooth prep 14 (not shown). This view illustrates the crown 15 prior to adding the finishing anatomy. In this figure, a relatively unfinished occlusal surface is shown. In addition, an unfinished buckle surface and an unfinished side surface are also shown. This is how the crown would appear after the buildup step.

As discussed above, conventional installation of crowns 15 takes a substantial amount of time and requires a substantial level of skill. Due to this, the cost of installing a crown 15 is expensive to the patient and require substantial resources to be expended on the part of the dental care professionals. An important factor related to this undue expense and effort is the time and effort it takes to carve the occlusal and buckle surfaces of the crown 15. If the crown 15 is not properly finished, the tooth will give an unnatural and unattractive appearance. As discussed below, this problem is eliminated by the invention because a substantial portion of the carving and anatomy creation is eliminated by the prefinished anatomy that attaches to a substantially blank coping.

FIG. 4B illustrates the prior art crown 15 shown in FIG. 4A after the anatomy 5 has been added. After the buildup step is complete, the cut-in step is completed to create the rough form of the outer surface of the crown. The next step in the prior art process would be to apply a layer of glaze for aesthetic purposes. The invention also applies a glaze layer. Once the glaze layer has been applied, the next step is to do the final carving which is the finish work that further makes the crown appear to be an actual tooth. Due to the detail provided in the prefinished anatomy, the amount of carving after the glaze has been applied is reduced to the point where it requires a negligible amount of time, or may not be necessary at all. Those skilled in the art will recognize that is very important that the anatomy 5 of the crown 15 match the natural anatomy 6 of adjacent teeth. Otherwise, the crown 15 will be noticeable and recognizable as a crown 15 rather than a tooth 1. As a result, dental technicians take great care, and spend a substantial amount of time, to obtain the best possible match. The elimination of this time and effort, by the invention, it's eventually increases the efficiency of the dental practice, and the quality of the resulting work.

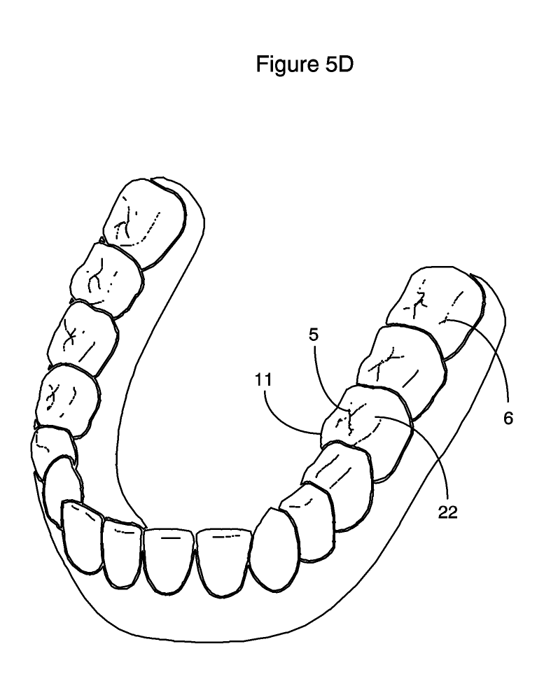

FIG. 5A illustrates a perspective view of a preferred embodiment of the coping 11 prior to installation of the prefinished anatomy 22 provided by this invention. This figure also illustrates the coping 11 in relation to other teeth in the jaw 9. As can be seen from this figure, the coping 11 has a relatively smooth, but unfinished upper surface. The coping 11 is temporarily installed on the prep 14 (not shown) to ensure it is the proper size. At this point the coping 11 is preferably made from soft porcelain. Those skilled in the art will recognize that while porcelain is used by many practitioners in the profession, other materials such as acrylic are also frequently used. Further, for ease of discussion, the features and advantages of the invention will be discussed in terms of the use of porcelain as the medium of choice used to fabricate a coping 11 or prefinished anatomy 22. However, it is understood that not only porcelain, but also acrylic and any other suitable material can be used to fabricate the coping 11 or prefinished anatomy 22. The only requirement for the material selected is that it have suitable aesthetic and mechanical properties.

Also shown in this figure is unfinished occlusal and buckle surfaces 21. The coping 11 shown in this figure has substantially unfinished occlusal and buckle surfaces 21. In this example, the unfinished occlusal and buckle surfaces 11 are where the prefinished anatomy 20 will be attached. In a conventional prior art crown 15, the technician would have to invest time and effort to properly carve the occlusal surface and create the proper anatomy. In this invention, the coping 11 only requires a simple unfinished occlusal and/or buckle surface 21. As a result, a substantial amount of time is saved during the installation of the crown.

FIG. 5B illustrates a preferred embodiment of the prefinished anatomy 22 being aligned with the coping 11. At this stage, the coping 11 is soft porcelain. The prefinished anatomy 22 is pressed into the unfinished occlusal and buckle surfaces 21 of the coping 11 and adjusted so that the coping 11 and the prefinished anatomy 22 are in proper alignment with adjacent teeth. Once the prefinished anatomy 22 has been attached to and aligned with the coping 11, they are placed in an oven to cure the porcelain. When the curing process is complete, the prefinished anatomy 22 and coping 11 have bonded together to form a completed crown that will be ready for installation.

FIG. 5C illustrates a preferred embodiment of the prefinished anatomy 22 after it has been permanently bonded to the coping 11 and then permanently installed on the prep 14 (not shown). Also shown in this figure is seam 23 which marks where the edge of the prefinished anatomy joins the coping 11. Seam 23 which is intended to help secure the prefinished anatomy 22 when installed. Seam 23 is removed by the technician by filing, and/or the addition of extra porcelain, if necessary. As shown in this figure, the prefinished anatomy 22 comes with anatomy 5 which is created under controlled conditions at the factory. This anatomy 5 is created with a high level of precision and quality. As a result, when the technician installs the prefinished anatomy 22, the resulting crown will have a very natural appearance which would typically require a highly skilled craftsmen to create. That is the principal advantage of this intention, namely, that it can allow an ordinary technician to achieve extraordinary levels of quality in less time than required by the prior art.

FIG. 5D illustrates the preferred embodiment shown in FIG. 5A. In this figure, the coping 11 and the prefinished anatomy 22 have been combined to form a crown. In addition, the scene 23 has been removed to create a natural looking tooth.

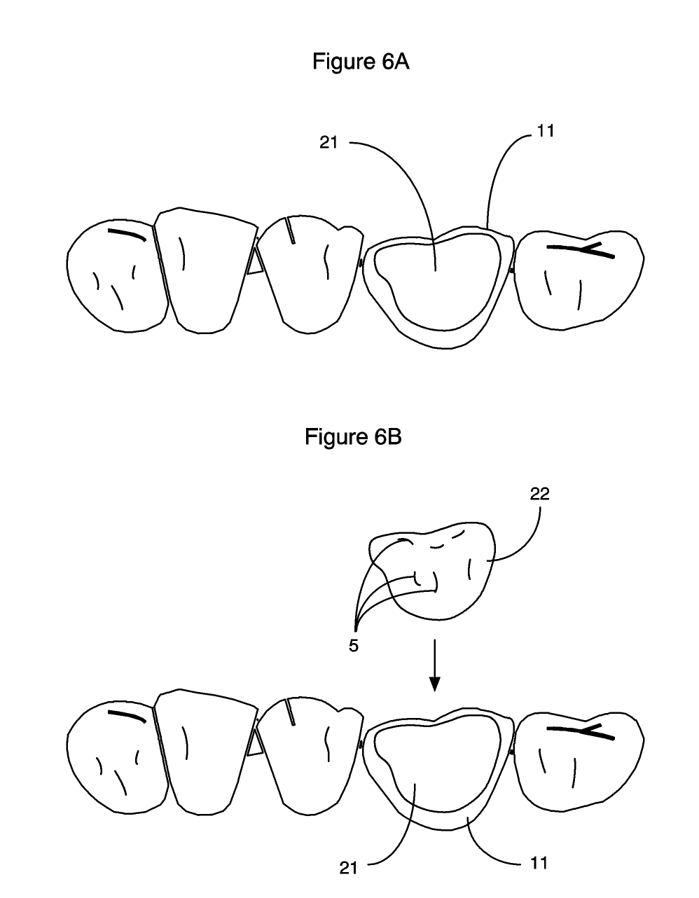

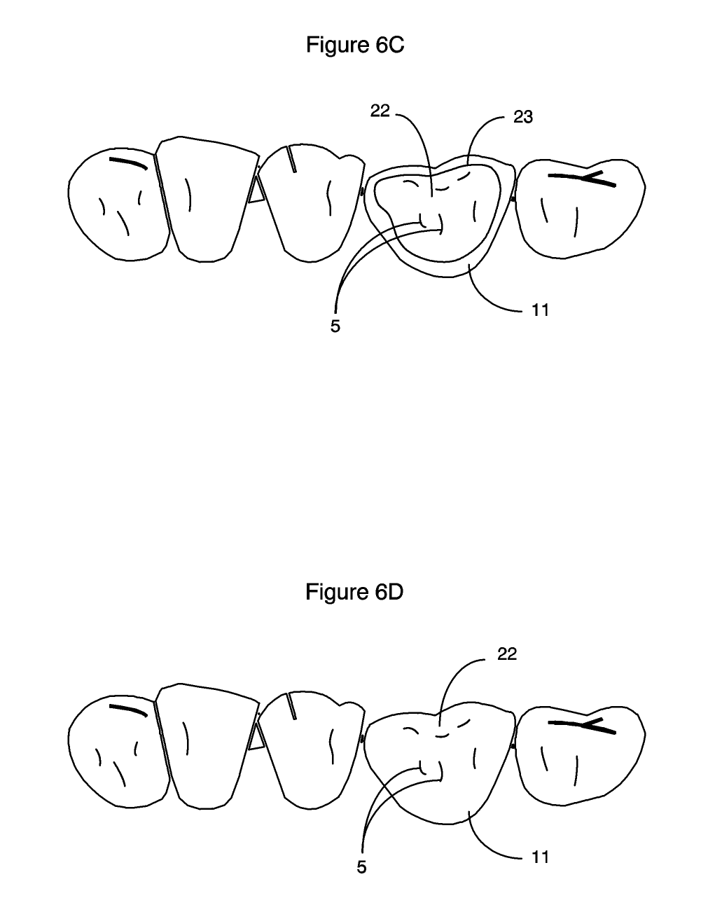

FIG. 6A is a side view of a preferred embodiment of the invention showing the coping 11 installed on a tooth prep 14 (not shown in this figure). This illustration provides a more detailed view of the side of the unfinished occlusal and buckle surface 21 which secures to a prefinished anatomy 22.

As can be seen from this figure, the coping 11 can be made in a standard form since its aesthetic appearance is dependent on the prefinished anatomy 22, and not on the coping 11.

FIG. 6B is a side view of a preferred embodiment of the prefinished anatomy 22 prior to its attachment to the unfinished occlusal and buckle surface 21 of the coping 11.

FIG. 6C is a side view of a preferred embodiment of the prefinished anatomy 22 after bonding to a coping 11 and after permanent installation on a tooth prep 14.

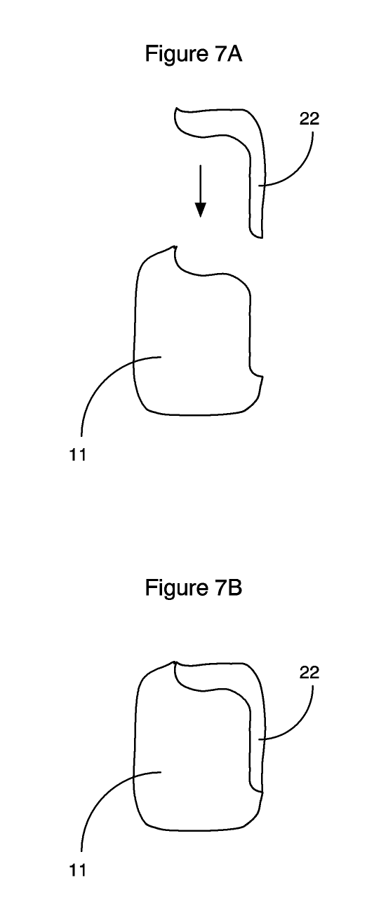

FIG. 7A illustrates a side end view of a preferred embodiment of the prefinished anatomy 22 prior to installation on a coping 11. In this figure, a buckle edge of prefinished anatomy 22 is shown extending downward. The top surface of prefinished anatomy 22 is intended to align with coping 11 when the prefinished anatomy 22 is secured to the coping 11.

FIG. 7B illustrates a side end view of a preferred embodiment of the prefinished anatomy 22 after installation on a coping 11. It is intended that the surface of coping 11 which contacts the prefinished anatomy 22 substantially informed to one another. However, since the coping 11 is fabricated from soft porcelain, material and be compressed together to form a secure fit. As a result, the two services do not have to perfectly match on another prior to installation.

Those skilled in the art will understand that when the prefinished anatomy 22 and coping 11 are manufactured, the most important detail in the manufacturing process is to ensure that they can be aligned together. In addition, the shape of the undersurface of the prefinished anatomy 22 should preferably for with the occlusal and buckle surfaces 11 of the coping 11.

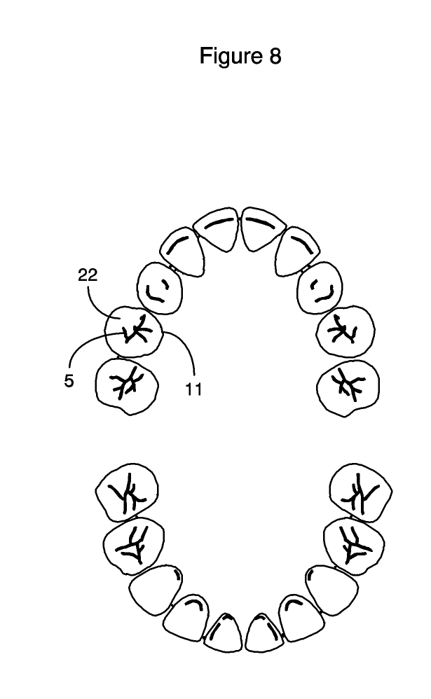

FIG. 8 is a top view of a preferred embodiment of the invention in which the prefinished anatomy 22 is shown installed on the coping 11. This figure illustrates the prefinished anatomy 22 after the crown is installed. As can be seen, the occlusal surface of the prefinished anatomy 22 comes complete with appropriate carving and anatomy. This eliminates the requirement that the technician go through the steps of creating the carving and anatomy. As a result, the crown can be installed in substantially less time and at less expense.

The prefinished anatomy 22 and coping 11 provided by this invention provide a method of rapidly installing a high-quality crown which increases patient satisfaction while reducing patient costs. In addition, the invention also increases profitability for the dental service while reducing its workload.

It is envisioned that prefinished anatomies 22 and copings 11 will be provided in the form of kits which are supplied to dental professionals. Each kit is intended to have a plurality of copings 11 and prefinished anomalies 22 for each type of tooth in a patient's mouth. This will allow the dental professional to select the best combination to suit a particular patient's physical characteristics.

For ease of discussion, the invention has been described in terms of a prefinished anatomy 22 which covers both the occlusal and buckle surfaces. Those skilled in the art will recognize that the principles and advantages of this invention can also be used to provide an advanced partial crown system in which only one surface, such as the occlusal or buckle surface, uses a prefinished anatomy 22. Further, it is also possible to provide prefinished anatomies 22 designed to fit only a portion of a surface, such as for use when creating an inlay.

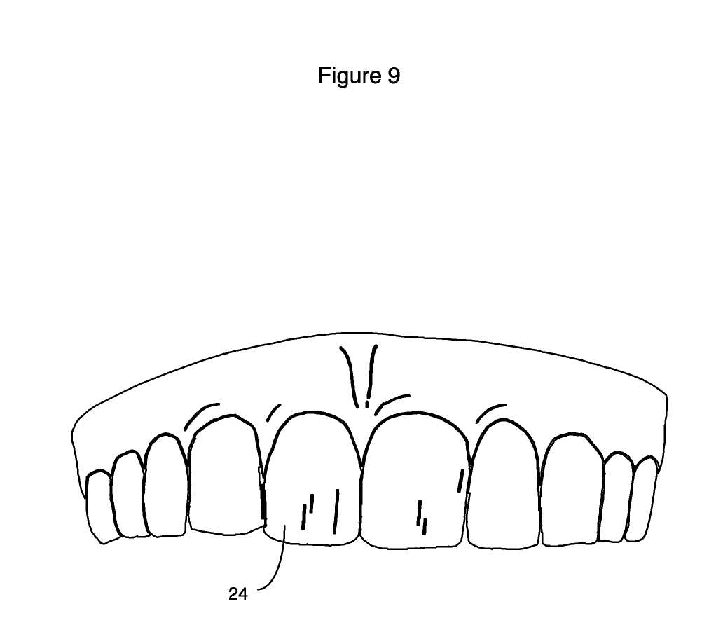

FIG. 9 is the front view of an alternative preferred embodiment in which the prefinished anatomy 24 is used in place of a prior art veneer. In the prior art, when a tooth required a veneer to correct a defect in appearance or perhaps damage to the surface of tooth, a dentist would typically grind the tooth and place a temporary surface on it while the permanent veneer is being manufactured. This method is relatively expensive because it requires at least two trips to the dentist's office, and a substantial amount of time on the part of the dentist. In addition to the dentist's time, the patient also has to spend a substantial amount of time traveling back and forth to the dentist's office. Further, the cost of the veneers are relatively expensive since they are custom-made.

The preferred embodiment shown in this figure provides a kit which holds a plurality of prefinished single surface anatomies 24 which are designed to cover a single surface of a tooth in the same manner as a prior art veneer. In this embodiment, each of the prefinished single surface anatomies 24 is selected from the kit by the dentist, and adhered to the surface of the tooth. This entirely eliminates the prior art requirement that a temporary veneer be installed while the permanent veneer was being manufactured. It provides both the dentist and the patient with a substantial savings in time. As a result, the savings can be translated into lower costs for the patient and improved profit for the dentist. In addition, since the prefinished single surface anatomies 24 of this embodiment can be manufactured in a closed environment and in quantity, the cost of the single surface anatomies 24 will be substantially less than for years.

While the invention has been described with respect to a preferred embodiment thereof, it will be understood by those skilled in the art that various changes in detail may be made therein without departing from the spirit, scope, and teaching of the invention. For example, the material used to construct the coping or prefinished anatomy may be anything suitable for their purposes, the size and shape of the open and prefinished anatomies will vary to sue a variety of patient physical attributes. The type and number of copings and prefinished anatomies supplied in a kit can vary to suit the needs of a particular business. Accordingly, the invention herein disclosed is to be limited only as specified in the following claims.

1. A two-piece crown assembly, further comprising:
a coping, having at least a portion of one surface substantially unfinished; and
a prefinished anatomy, sized such that it conforms to at least a portion of the substantially unfinished surface of the coping;
means to secure the prefinished anatomy to the coping such that the coping and the prefinished anatomy form a dental crown.
